(19) United States
(12) Patent Application Publication
(10) Pub. No.: US 2023/0188204 A1
(43) Pub. Date: Jun. 15, 2023

(54) Minimizing Fronthaul Data Load and Beam Management realization in Cellular Non terrestrial Networks Using Satellite Networks

(71) Applicant: Parallel Wireless, Inc., Nashua, NH (US)

(72) Inventors: Ofir Ben Ari Katzav, Zur Itshak (IL); Ido Shaked, Alfei Menashe (IL)

(21) Appl. No.: 18/064,929

(22) Filed: Dec. 12, 2022

Related U.S. Application Data
(60) Provisional application No. 63/288,138, filed on Dec. 10, 2021.

(51) Int. Cl. H04B 7/185

(52) U.S. Cl. CPC H04B 7/18532

(57) ABSTRACT

A method is described of minimizing fronthaul data load and beam management realization in a cellular non-terrestrial network using a satellite network system, comprising: providing a plurality of cells of a cellular service based on satellite systems in a satellite constellation to be used in a pre-defined pattern when being translated into beams, wherein a given cell covers more than a single geographic location in a non-adjacent manner; wherein a reuse pattern of cells avoids two cells covering an overlapping area; and the reuse pattern also avoids neighbor cells.

### CROSS-REFERENCE TO RELATED APPLICATIONS

The present application claims priority under 35 U.S.C. § 119(e) to U.S. Provisional Patent App. No. 63/288,138, filed Dec. 10, 2021 and having the same title as the present application, and which is hereby incorporated by reference in its entirety. As well, the present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and U.S. Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

Cellular service based on satellite systems in low earth orbit (LEO) constellations, or other such orbital systems, are a promising solution for extending broadband coverage to areas not connected to a terrestrial infrastructure.

High-throughput Satellite or HTS is a communication satellite that provides more throughput than conventional communication satellites (Fixed Satellite Service). Higher-throughput refers to a significant increase in capacity when using the same amount of orbital spectrum. The increase in capacity typically ranges from 2 to more than 100 times as much capacity as the classic FSS (Fixed Satellite Service). This significantly reduces the cost per bit.

To gain this significant increase in capacity an HTS leverages a high-level of frequency reuse and spot beam technology. Traditional satellite technology utilizes a broad single beam or a few beams which cover large areas that are sometimes thousands of kilometers. Spot beam technology uses multiple narrow beams which allow it to re-use the same frequency band.

### BRIEF DESCRIPTION OF THE DRAWINGS

FIG. 1 is a schematic diagram of a multiplexed cellular satellite access system, in accordance with some embodiments.

FIG. 2 is a schematic diagram of cell identifiers (cell IDs) overlaid over an underlying physical geographic region in an exemplary pattern, in accordance with some embodiments.

FIG. 3 is a further schematic diagram of a multiplexed cellular satellite access system, in accordance with some embodiments.

FIG. 4 is a schematic network architecture diagram for 3G and other-G prior art networks, in accordance with some embodiments.

FIG. 5 is an enhanced eNodeB for performing the methods described herein, in accordance with some embodiments.

FIG. 6 shows a coordinating server for providing services and performing methods as described herein, in accordance with some embodiments.

### SUMMARY

In a first embodiment, a method is described of minimizing fronthaul data load and beam management realization in a cellular non-terrestrial network using a satellite network system, comprising: providing a plurality of cells of a cellular service based on satellite systems in a satellite constellation to be used in a pre-defined pattern when being translated into beams, wherein a given cell covers more than a single geographic location in a non-adjacent manner; wherein a reuse pattern of cells avoids two cells covering an overlapping area; and the reuse pattern also avoids neighbor cells.

The method may further comprise assigning the non-adjacent manner as a pattern of cellular coverage. The plurality of cells may be provided by orbital base stations in the satellite constellation. Baseband processing may be performed at orbital base stations in the satellite constellation. A mesh network may be used as backhaul for orbital base stations.

In a second embodiment, a non-terrestrial cellular network is described, comprising: an orbital radio station configured to broadcast a single cell identifier to a plurality of non-contiguous geographic areas; and a baseband processing system configured to provide service to user equipments that attach to the orbital radio station using the single cell identifier.

The orbital radio station uses narrow beamwidth beams to deliver service to ground stations. The orbital radio station broadcasts an EUTRAN cell global identifier (eCGI) to a plurality of ground-based user equipments (UEs) in a non-contiguous area. The single cell identifiers may be at least one of an EUTRAN cell global identifier (ECGI), a cell global identifier (CGI), a service area identifier (SAI), a routing area identifier (RAI), a tracking area identifier (TAI), a location area identifier (LAI). The baseband processing system may be enabled to be scalable by adding additional users without adding additional cell IDs.

### DETAILED DESCRIPTION

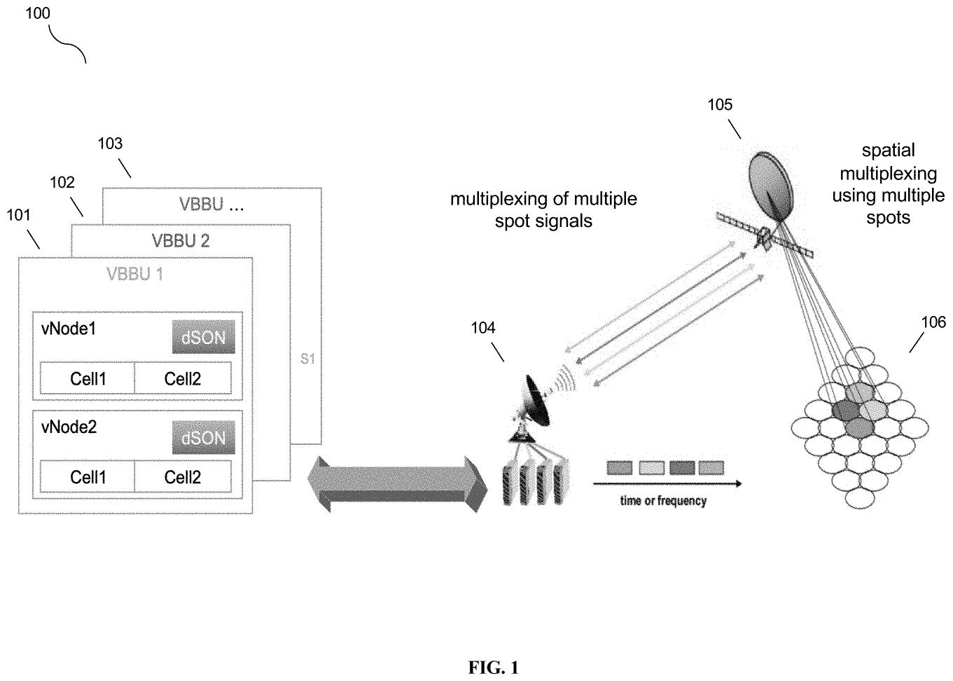

The suggested solution for an LTE LEO based system can be described in the block diagram shown in FIG. 1.

HTS satellites mostly uses at least 100 beams (or more), therefore cellular processing unit such as baseband processor required to produce at least 100 cells.

In terms of required compute power at the cellular processing unit, such a high number of cells will require high number of compute power, which will make this solution complicated and expensive.

However, from the cellular processor perspective, high number of users per cell is an easier target than high number of cells.

In some embodiments, a satellite may create limited and much lower number of streams (cells) that will be reused in a defined pattern when being translated into beams. The above means that a given cell will cover more than a single geographic location in non-adjacent manner.

FIG. 1 100 shows multiple schematic cells, shown as virtual baseband units (vBBUs) 101, 102, 103, which each have their own virtual nodes and virtual cells, and which have dSON capability (distributed self-organizing network). Multiple spot signals are multiplexed between orbital satellite 105 and ground station 104, such that the same satellite 105 transmits signal to a wide geographic area 106 using spatial multiplexing with multiple spots. vBBUs 101, 102, 103 may be located on the satellite, in some embodiments, or may be located on the ground, in other embodiments. In some embodiments, the identifier for a single cell is shared across multiple geographic areas 106. In some embodiments, the cell corresponding to the shared identifier is handled by a single vBBU 101, allowing scaleup of resources as the number of users increases without adding additional cell identifiers; in other embodiments each cell identifier is shared across multiple vBBUs corresponding to geographic area, such that the overhead for cell identifier is shared but the number of users is able to be scaled by adding additional vBBUs; in other embodiments a single cell identifier is shared across multiple virtual nodes or containers within a single vBBU, such that, e.g., vBBUl has two vNodes 1 and 2, each providing service to cell 1 and cell 2.

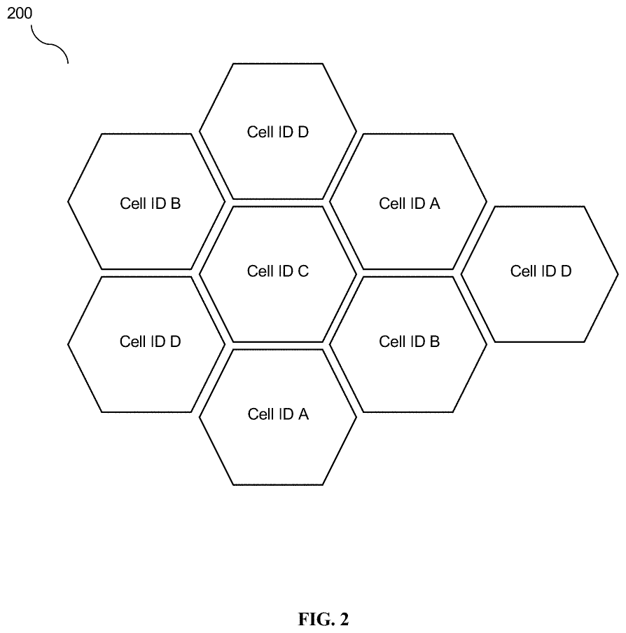

FIG. 2 is a schematic diagram 200 of cell identifiers (cell IDs) overlaid over an underlying physical geographic region in an exemplary pattern, in accordance with some embodiments. As mentioned, the same eNB ID and cell ID (or other necessary identifiers such as CGI, ECGI, etc.) are reused to cover multiple areas. Unlike in the traditional cellular approach, the base station will create discontinuous geographical coverage for a single logical cell. In order to function properly at the cell boundary, the reuse pattern shall avoid two cell IDs covering an overlapping area, as well as neighbor cells having the same cell ID. Cell IDs A, B, C, D do not overlap and do not have adjacency with an area having the same cell ID, but create a pattern that can be repeated over a wide area with limitation based on the number of carriers, users, etc. supported by the satellite base station system.

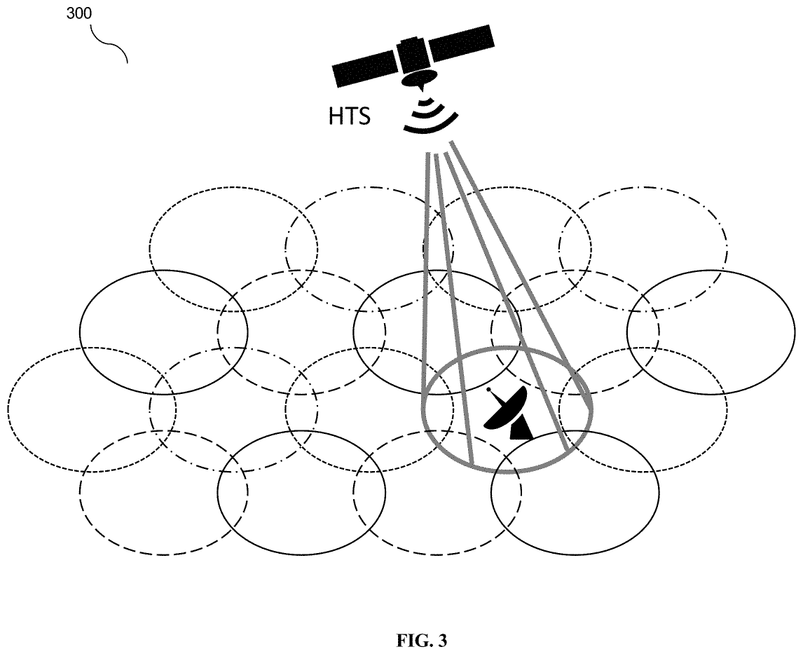

FIG. 3 is a further schematic diagram 300 of a multiplexed cellular satellite access system, in accordance with some embodiments. A high throughput satellite provides coverage to a particular ground station; the pattern of coverage described in FIG. 2 is represented in FIG. 3 using differing line styles. Implementation of non-terrestrial network (NTN) cellular network in the straightforward approach means heavy requirements for compute power and high data rate demands between the ground stations and the satellite network. Instead of that, this disclosure aims to combine multiple satellite beams, which are considered as independent cellular carriers, in such a way that the compute and data rate requirements are relaxed by significant factors. The brain of the beam combination into logical cell ID is done in a way to prevent interference, allow common hand-over scenarios to remain untouched and more.

The beam combination algorithm can be defined naively as static allocation, or, can be allocated using an algorithm such as a graph coloring algorithm or any suitable alternative.

As enhancement to that, and considering the power consumption tight budget of such solution (mainly the satellite network), carrier activation/deactivation or equivalently, satellite beam activation/deactivation, considerations may be combined in the beam grouping selection per cellular carrier ID. For such, we consider the user's load applicable in each physical beam coverage area and based on this perform reassignment of beams to other cellular cell IDs—this creates load balancing on the cellular processing units which allows to reduce the demands of it even further. Satellite power saving is applicable by turning off beams that are not in use and potentially retuning other beams to back up those geographical areas.

Methods are described herein for providing location identifiers or cell IDs, in some embodiments. User Location Information (ULI) is an extendable IE that is coded. The CGI, SAI, RAI, TAI, ECGI and LAI identity types are defined in 3GPP TS 23.003. The ULI IE shall contain only one identity of the same type (e.g. more than one CGI cannot be included), but ULI IE may contain more than one identity of a different type (e.g. ECGI and TAI). The flags LAI, ECGI, TAI, RAI, SAI , CGI and Macro eNodeB ID in octet 5 indicate if the corresponding type shall be present in a respective field or not. If one of these flags is set to “0”, the corresponding field shall not be present at all. If more than one identity of different type is present, then they shall be sorted in the following order: CGI, SAI, RAI, TAI, ECGI, LAI, Macro eNodeB ID. These identities can be adapted to allow multiple non-contiguous regions to share the same cell identity, in accordance with some embodiments.

In some embodiments, a single orbital satellite may broadcast multiple cell IDs, but such that the multiple cell IDs are shared across multiple non-contiguous regions in a pattern corresponding to this disclosure. In some embodiments, multiple orbital satellites may provide broadcast of individual cell IDs in a non-contiguous fashion so as to cover a large region using narrow beams in coordination with each other

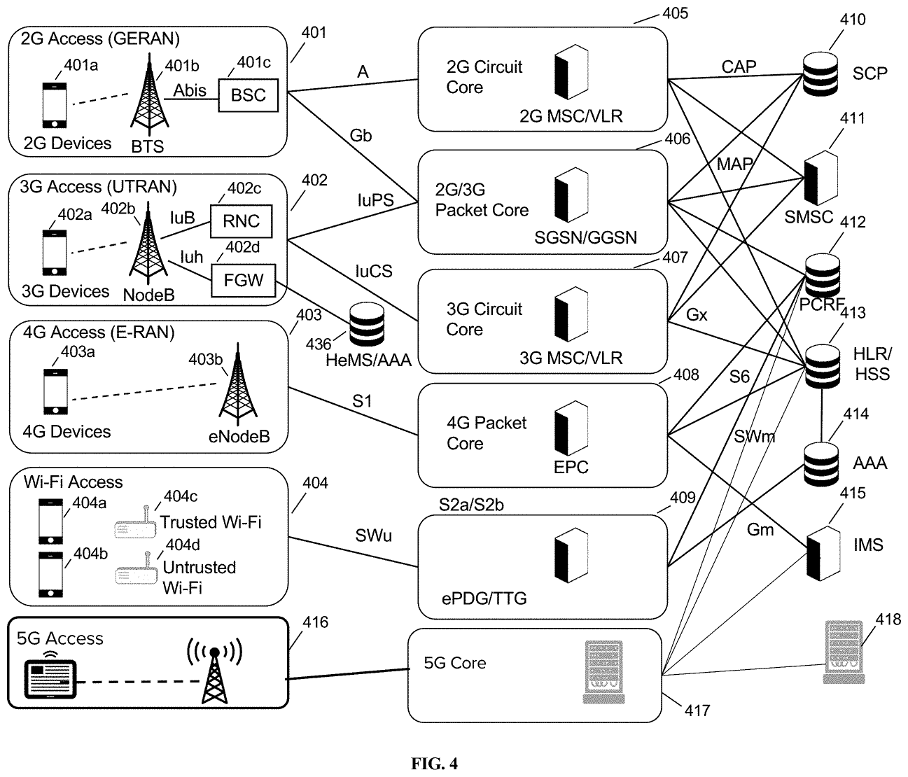

FIG. 4 is a schematic network architecture diagram for 3G and other-G prior art networks, in accordance with some embodiments. The diagram shows a plurality of “Gs,” including 2G, 3G, 4G, 5G and Wi-Fi. 2G is represented by GERAN 401, which includes a 2G device 401a, BTS 401b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b may access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 5G core 417 is shown using a single interface to 5G access 416, although in some cases 5G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas may be connected with the telephone network and the Internet by a high bandwidth optical fiber or wireless backhaul connection in addition to the satellite backhaul connection described above.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

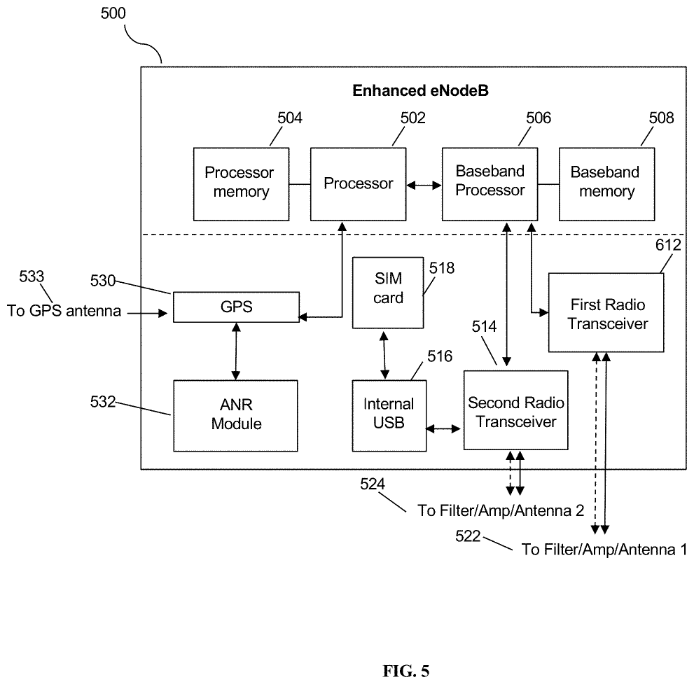

FIG. 5 is an enhanced eNodeB for performing the methods described herein, in accordance with some embodiments. eNodeB 500 may include processor 502, processor memory 504 in communication with the processor, baseband processor 506, and baseband processor memory 508 in communication with the baseband processor. Mesh network node 500 may also include first radio transceiver 512 and second radio transceiver 514, internal universal serial bus (USB) port 516, and subscriber information module card (SIM card) 518 coupled to USB port 516. In some embodiments, the second radio transceiver 514 itself may be coupled to USB port 516, and communications from the baseband processor may be passed through USB port 516. The second radio transceiver may be used for wirelessly backhauling eNodeB 500 and may be a satellite radio, in some embodiments. In some embodiments a mesh network may be used for backhaul, with one designated backhaul mesh node performing backhauling to a designated ground station that is visible based on the orbit of the constellation, while other constellation nodes that are out of sight of the designated ground station may use the designated backhaul mesh node. Meshing is described in the documents incorporated by reference above.

Processor 502 and baseband processor 506 are in communication with one another. Processor 502 may perform routing functions, and may determine if/when a switch in network configuration is needed. Baseband processor 506 may generate and receive radio signals for both radio transceivers 512 and 514, based on instructions from processor 502. In some embodiments, processors 502 and 506 may be on the same physical logic board. In other embodiments, they may be on separate logic boards.

Processor 502 may identify the appropriate network configuration, and may perform routing of packets from one network interface to another accordingly. Processor 502 may use memory 504, in particular to store a routing table to be used for routing packets. Baseband processor 506 may perform operations to generate the radio frequency signals for transmission or retransmission by both transceivers 510 and 512. Baseband processor 506 may also perform operations to decode signals received by transceivers 512 and 514. Baseband processor 506 may use memory 508 to perform these tasks.

The first radio transceiver 512 may be a radio transceiver capable of providing LTE eNodeB functionality, and may be capable of higher power and multi-channel OFDMA. The second radio transceiver 514 may be a radio transceiver capable of providing LTE UE functionality. Both transceivers 512 and 514 may be capable of receiving and transmitting on one or more LTE bands. In some embodiments, either or both of transceivers 512 and 514 may be capable of providing both LTE eNodeB and LTE UE functionality. Transceiver 512 may be coupled to processor 502 via a Peripheral Component Interconnect-Express (PCI-E) bus, and/or via a daughtercard. As transceiver 514 is for providing LTE UE functionality, in effect emulating a user equipment, it may be connected via the same or different PCI-E bus, or by a USB bus, and may also be coupled to SIM card 518. First transceiver 512 may be coupled to first radio frequency (RF) chain (filter, amplifier, antenna) 522, and second transceiver 514 may be coupled to second RF chain (filter, amplifier, antenna) 524.

SIM card 518 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 500 is not an ordinary UE but instead is a special UE for providing backhaul to device 500.

Wired backhaul or wireless backhaul may be used in addition to the satellite backhaul connection described above. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

Satellite backhaul may be used, in some embodiments. Satellite backhaul may include an antenna array and a motorized mount for tracking a backhauling satellite across the sky, in some embodiments. Ground stations with satellite backhaul may be used in a one-per-cell configuration or in a multiple cells per ground station configuration.

A GPS module 530 may also be included, and may be in communication with a GPS antenna 532 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 532 may also be present and may run on processor 502 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

In some embodiments, the base station described herein with respect to FIG. 5 may be a base station that is in space and in orbit around the earth in a regular orbit and in a constellation with other satellites. In some embodiments, the base station may be directly backhauled to an earth ground station, or backhauled via a mesh link to another orbital station, or both. In some embodiments, the orbital base stations may provide cellular service directly to UEs on the ground. The orbit of the orbital base stations may be determined based on factors such as desired latency, throughput, and reliability, in some embodiments, as reliability is affected by the fraction of the day that the orbital base station spends below the horizon. In some embodiments, power savings techniques such as powering down carriers or cells, etc., may be used to conserve power. In some embodiments, where the orbital base station is capable of providing either direct cellular service as multiple cells or consolidated cellular service using the same cell identifier across multiple noncontiguous areas, the orbital base station may select one option or the other option based on factors such as expected power consumption, desired heat generation, etc.

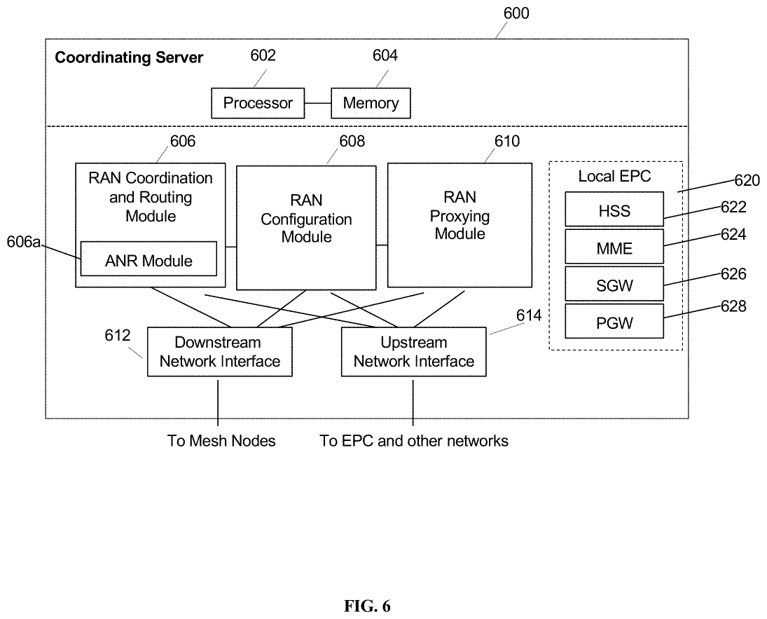

FIG. 6 shows a coordinating server for providing services and performing methods as described herein, in accordance with some embodiments. Coordinating server 600 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a may perform the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 may coordinate multiple RANs using coordination module 606. In some embodiments, coordination server may also provide proxying, routing virtualization and RAN virtualization, via modules 610 and 608. In some embodiments, a downstream network interface 612 is provided for interfacing with the RANs, which may be a radio interface (e.g., LTE), and an upstream network interface 614 is provided for interfacing with the core network, which may be either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 may include local HSS 622, local MME 624, local SGW 626, and local PGW 628, as well as other modules. Local EPC 620 may incorporate these modules as software modules, processes, or containers. Local EPC 620 may alternatively incorporate these modules as a small number of monolithic software processes. Modules 606, 608, 610 and local EPC 620 may each run on processor 602 or on another processor, or may be located within another device.

In some embodiments, coordinator 600 may be configured to expect noncontiguous areas to be covered by the same cell as described hereinabove, and may accept, without rejecting or validating them, messages from UEs or from one or more base stations that suggest that the cell covers a noncontiguous area. In some embodiments, coordinator 600 may maintain a mapping of geographic coordinates such as latitude/longitude or horizon/azimuth coordinates to cell identifiers, and may incorporate non-contiguous cells into its storage schema.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of minimizing fronthaul data load and beam management realization in a cellular non-terrestrial network using a satellite network system, comprising:
providing a plurality of cells of a cellular service based on satellite systems in a satellite constellation to be used in a pre-defined pattern when being translated into beams, wherein a given cell covers more than a single geographic location in a non-adjacent manner;
wherein a reuse pattern of cells avoids two cells covering an overlapping area; and
wherein the reuse pattern also avoids neighbor cells.

2. The method of claim 1, further comprising assigning the non-adjacent manner as a pattern of cellular coverage.

3. The method of claim 1, wherein the plurality of cells are provided by orbital base stations in the satellite constellation.

4. The method of claim 1, wherein baseband processing is performed at orbital base stations in the satellite constellation.

5. The method of claim 1, wherein a mesh network is used as backhaul for orbital base stations.

6. A non-terrestrial cellular network, comprising:
an orbital radio station configured to broadcast a single cell identifier to a plurality of non-contiguous geographic areas; and
a baseband processing system configured to provide service to user equipments that attach to the orbital radio station using the single cell identifier.

7. The non-terrestrial cellular network of claim 6, wherein the orbital radio station uses narrow beamwidth beams to deliver service to ground stations.

8. The non-terrestrial cellular network of claim 6, wherein the orbital radio station broadcasts an EUTRAN cell global identifier (eCGI) to a plurality of ground-based user equipments (UEs) in a non-contiguous area.

9. The non-terrestrial cellular network of claim 6, wherein the single cell identifiers is at least one of an EUTRAN cell global identifier (ECGI), a cell global identifier (CGI), a service area identifier (SAI), a routing area identifier (RAI), a tracking area identifier (TAI), a location area identifier (LAI).

10. The non-terrestrial cellular network of claim 6, wherein the baseband processing system is enabled to be scalable by adding additional users without adding additional cell IDs.
